(19) United States
(12) Patent Application Publication
(10) Pub. No.: US 2015/0324943 A1
(43) Pub. Date: Nov. 12, 2015

(54) SYSTEM AND METHOD FOR REMOTE PRESENCE MONITORING

(71) Applicants: Sang Hee Han, Los Angeles, CA (US); Lance Mayfield, Fullerton, CA (US)

(72) Inventors: Sang Hee Han, Los Angeles, CA (US); Lance Mayfield, Fullerton, CA (US)

(21) Appl. No.: 14/272,424

(22) Filed: May 7, 2014

(51) Int. Cl. G06Q 50/22; G06Q 10/06; G06Q 10/10

(52) U.S. Cl. CPC G06Q 50/22; G06Q 10/1091; G06Q 10/06398

(57) ABSTRACT

A system and method for monitoring a presence of an individual in a geo-fence relative to a central facility. The invention effectuates tracking of field workers for home health and home care as well as a plethora of other applications. The invention provides real time data on the duration of time the care provider spends with a patient while holding the care provider accountable for being on site for the duration of care. In a most general embodiment, the invention includes means for receiving and storing geo-fence data on a first mobile computing and communications platform; logging time at a location defined by said geo-fence data; and transmitting the time log to a second computing platform. In a specific embodiment, the invention includes means for biometrically identifying a care provider within the geo-fence and outputting data to the second computing platform with respect thereto. The biometric identification may be implemented with fingerprint, voice print, facial recognition or other suitable means.

### BACKGROUND OF THE INVENTION

1. Field of the Invention

The present invention relates to computing systems. More specifically, the present invention relates to systems and methods for remote presence monitoring using mobile computing and communications platforms.

2. Description of the Related Art

In many industries and applications, there is a need for the ability to monitor the presence of a remotely located or mobile individual or asset in a specified area.

One such application is the home health care industry. The home health care industry currently suffers from a lack of accountability. Nurses, therapists, and care providers are known to show up on site and leave immediately or fail to show up at all. Given that care presence is reported and logged in manually by the care provider, the absence of accountability has not only put unanticipated financial burden on an already strained healthcare system but also results in a substantial decrease in healthcare quality provided to patients. At present, no solution exists for automatically and electronically monitoring care provider presence and hours at a patient's location.

Hence, there is a need in the art for a mobile application capable of providing real time data collection and reporting of the location of a care provider on-site as well as time spent providing care to a patient.

### SUMMARY OF THE INVENTION

The need in the art is addressed by the system and method of the present invention for monitoring a presence of an individual in a remote location relative to a central facility. The invention effectuates tracking of field workers for home health and home care as well as a plethora of other applications. The invention provides real time data on the duration of time the care provider spends with a patient while holding the care provider accountable for being on site for the duration of care.

In a most general embodiment, the invention includes means for receiving and storing geo-fence data; logging time at a location defined by said geo-fence data on a first computing and communications platform; and transmitting the time log to a second computing platform.

In a specific embodiment, the invention includes means for biometrically identifying a care provider within the geo-fence and outputting data to the second computing platform with respect thereto. The biometric identification may be implemented with fingerprint, voice print, facial recognition or other suitable means.

### BRIEF DESCRIPTION OF THE DRAWINGS

FIG. 1 is a diagram that illustrates the key systems utilized in accordance with the present teachings along with the parties that provide input thereto and outputs therefrom.

FIGS. 2a-2d are diagrams that demonstrate the operation of the system and method of the present invention for monitoring a presence of an individual in a remote location relative to a central facility.

FIG. 3 is a diagram showing multiple devices positioned within a number of geo-fences set up for one or more patients in accordance with the present teachings.

FIG. 4 is a flow chart of an illustrative implementation of the system and method for monitoring the presence of an individual in a remote location relative to a central facility of the present invention.

FIG. 5 is a simplified flow diagram of an illustrative embodiment of the client side software functionality in accordance with the present teachings.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

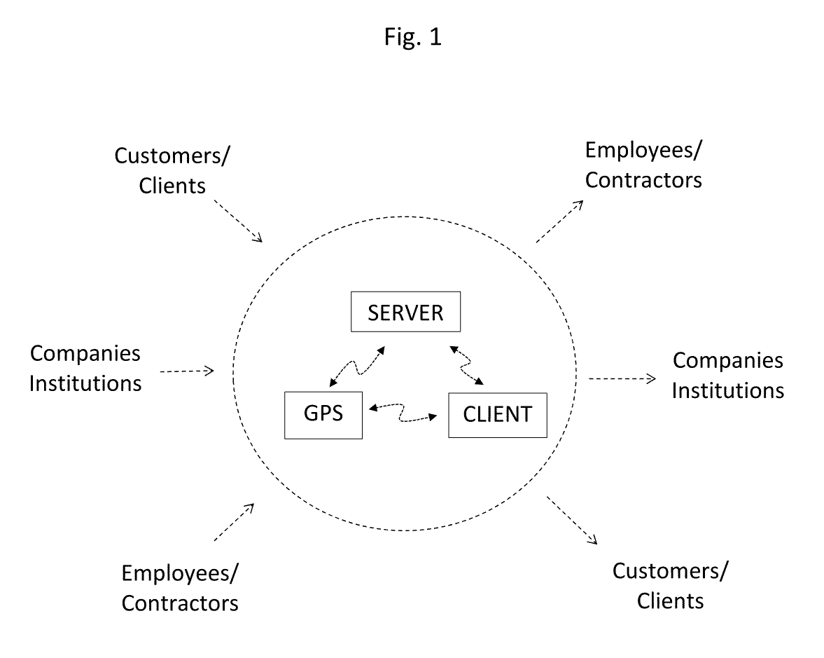

FIG. 1 is a diagram that illustrates the key systems utilized in accordance with the present teachings along with the parties that provide input thereto and outputs therefrom.

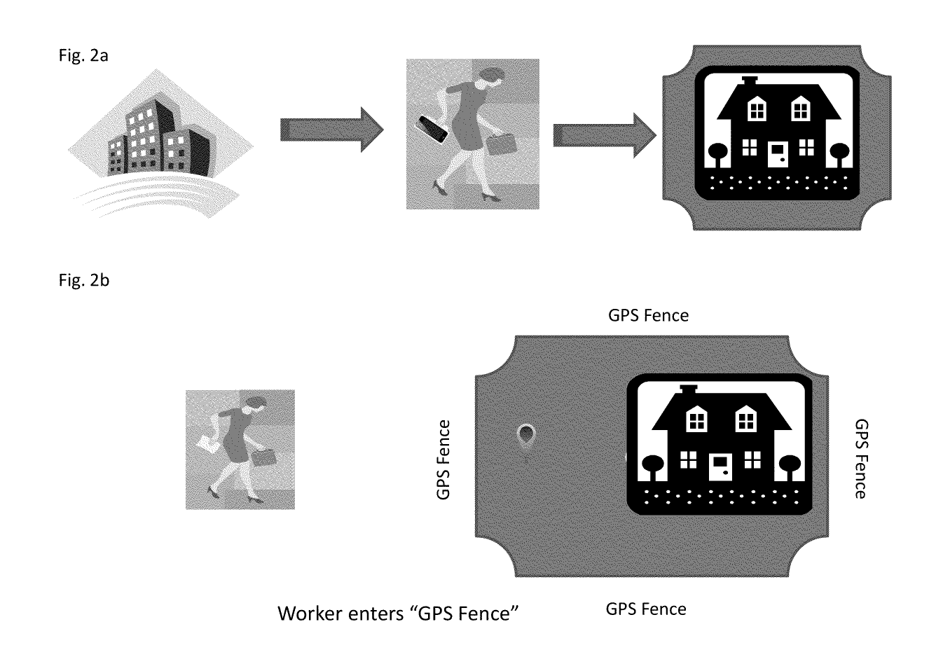

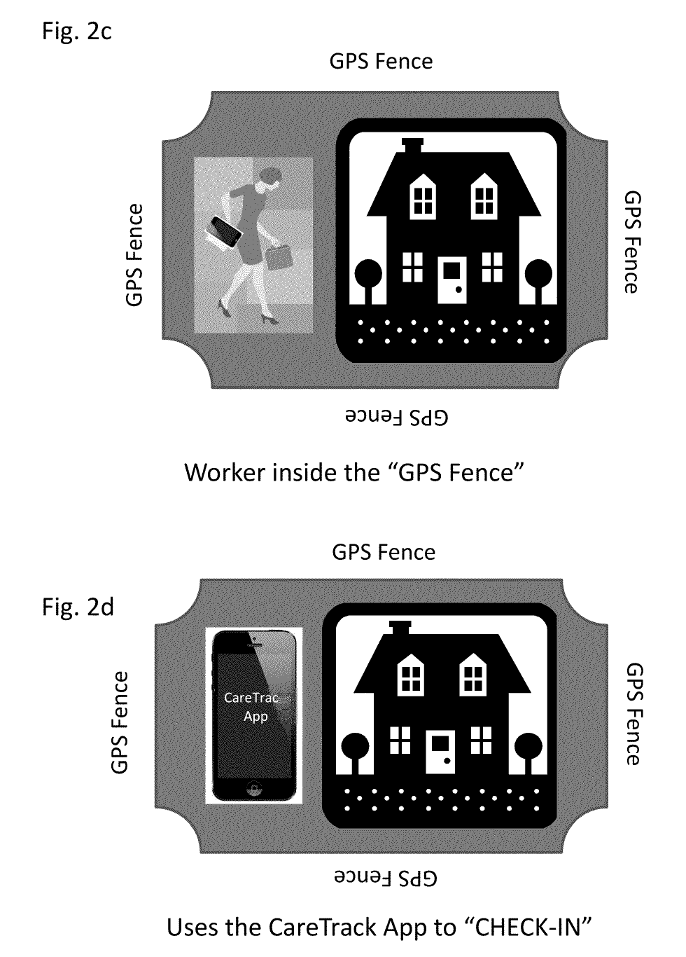

FIGS. 2a-2d demonstrate the operation of the system and method of the present invention for monitoring a presence of an individual in a remote location relative to a central facility. As discussed more fully below, the present invention effectuates tracking of field workers. In the illustrative application, the present teachings are disclosed in the context of home health and home care. However, those of ordinary skill in the art will appreciate that the present teachings may be applied to a plethora of other applications as well.

As illustrated in FIG. 2a, in a typical home health care scenario, a worker is dispatched from a central facility to a home. On arrival, in accordance with the present teachings, the worker enters a geo-fence at the location of the patient's home. (See FIG. 2b). The automatic establishment of geo-fences is well-known in the art. See, for example, U.S. Pat. No. 8,362,887 issued Jan. 29, 2013 to Morgan et al. and entitled AUTOMATED GEO-FENCE BOUNDARY CONFIGURATION AND ACTIVATION, the teachings of which are hereby incorporated herein by reference.

As shown in FIGS. 2c and 2d, on arrival, the worker logs into an application (currently commonly referred to as an ‘app’) running on her Smartphone, tablet, personal computer or other computing platform having a processor and a memory implemented with a tangible medium. This starts a clock running either on the mobile device or on a server (not shown) which runs for the duration of the worker's stay within the geo-fenced area. On departure, this data is reported (uploaded) to the server. Hence, the system and method disclosed more fully below provides real time data on the duration of time the care provider spends with a patient and thereby allows for the care provider to be held accountable for being on site for a specified period of time.

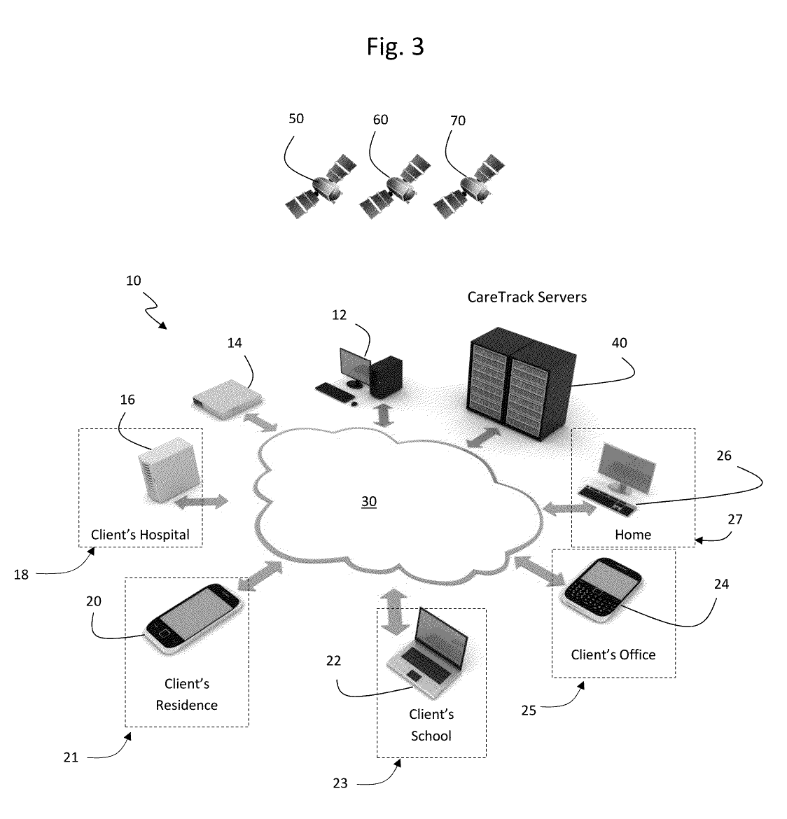

FIG. 3 is a diagram showing multiple devices 12-26 (even numbers only) communicating with a central server 40, via a network, such as the Internet, 30 of which some 16, 20, 22, 24 and 26 are positioned within a number of geo-fences set up for one or more patients 18, 21, 23, 25 and 27, respectively. The geo-fences may be established using the Global Positioning System (GPS) satellite system or by triangulation using cell towers or other suitable methods. As is known in the art GPS requires at least three satellites 50, 60 and 70 to fix one's location on the surface of the earth. The geo-fence may be established and stored on the worker's mobile platform or on the server or both.

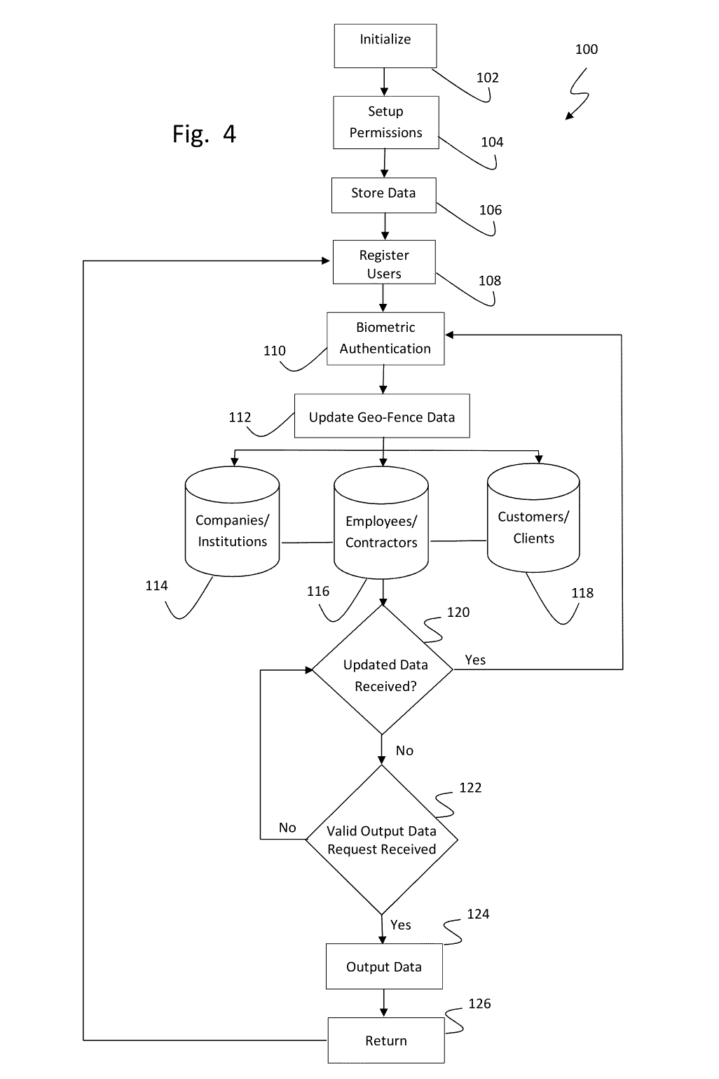

FIG. 4 is a flow chart of an illustrative implementation of the system and method for monitoring the presence of an individual in a remote location relative to a central facility of the present invention. In the illustrative embodiment, the method 100 depicted in FIG. 4 is implemented on a server in a standalone server farm or via the cloud (a group of servers accessible through a public network). See http://en.wikipedia.org/wiki/Cloud_computing. In operation 100, at step 102 the system is initialized. In step 104 permissions are set up by an administrator setting the server access parameters for customers/clients, companies/institutions and employees/contractors depicted in FIG. 1. At step 106, data from these entities is stored in one of several databases 114, 116 and 118.

At step 108, the server registers remote users working out in the field. At step 110, the server examines the user's biometric credentials. For this purpose, in accordance with the present teachings, when the worker has entered the geo-fence for a patient, the field worker authenticates and confirms his or her presence using fingerprint verification, voice print data or facial recognition. As another alternative, an alpha-numeric code can be randomly generated by the server and sent to the worker's phone on a regular or irregular basis as a prompt which the user must return to the server within a predetermined time frame to verify presence. When authenticated at step 110, the system 10 accepts geo-fence update log data and stores it in the appropriate database 114, 116 and/or 118 for access by the stakeholders (customers/clients, companies/institutions and employees/contractors). The CareTrack server system 40 of the present invention (depicted in FIG. 3) then resets and waits for more data at step 120 and outputs data on request at steps 122 and 124. In this case, the system goes into a hold state to await more log data or user logins at step 126.

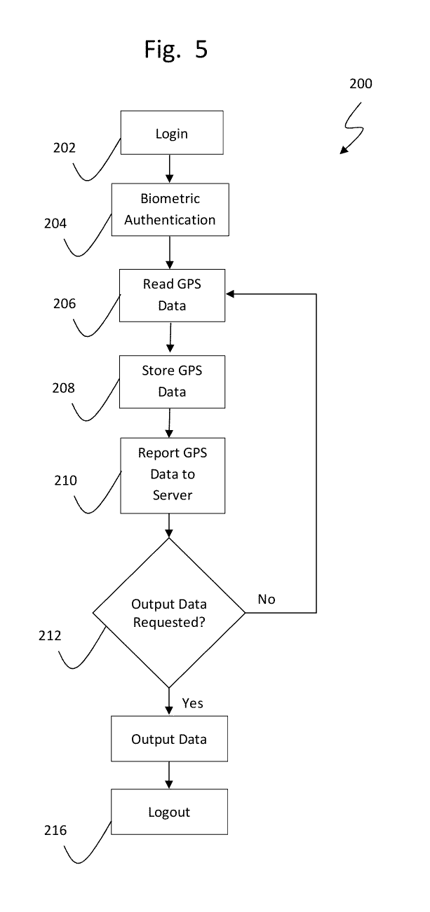

FIG. 5 is a simplified flow diagram of an illustrative embodiment of the client side software functionality in accordance with the present teachings. As mentioned above, the flow diagram 200 of FIG. 5 is adapted to be executed by a processor running software stored in physical tangible memory on a smart phone, tablet, laptop or other mobile computing and communications platform. In step 202, the field worker logs in upon entry into the geo-fence area and provides biometric identification at step 204. At steps 206-210, the client system reads, stores and reports time on station, at the GPS location, to the server 40 (FIG. 3). At step 212, the system checks for an output data request from the user. Whether one is received or not, the system awaits more time log and GPS update data. If an output data request is received at step 212, the data is output at step 214.

Those having ordinary skill in the art and access to the present teachings will recognize additional modifications, applications and embodiments within the scope thereof. As mentioned above, the system is not limited to the use of GPS data. Other systems may be used to create, store and test for geo-fences. In addition, the present teachings are not limited to use with any particular type of computing/communications equipment. Further, the present teachings are not limited to home health care applications. Indeed, other obvious applications include security, manufacturing, etc.

It is therefore intended by the appended claims to cover any and all such applications, modifications and embodiments within the scope of the present invention.

Accordingly,

What is claimed is:

1. A system for monitoring a presence of an individual in a remote location relative to a central facility comprising:
means for receiving and storing geo-fence data;
means for logging time at a location defined by said geo-fence data on a first computing and communications platform; and
means for transmitting said time log to a second computing and communications platform.

2. The invention of claim 1 wherein said first computing and communications platform further includes means for biometrically identifying a user within said geo-fence and outputting data to said second computing platform with respect thereto.

3. The invention of claim 2 wherein said means for biometrically identifying a user includes means for detecting a fingerprint.

4. The invention of claim 2 wherein said means for biometrically identifying a user includes means for detecting a voice print.

5. The invention of claim 2 wherein said means for biometrically identifying a user includes facial recognition means.

6. The invention of claim 1 wherein said first computing and communications platform includes first computer software stored in a first tangible medium.

7. The invention of claim 6 wherein said first computing and communications platform includes a first electronic processor that executes said first computer software to store said geo-fence data.

8. The invention of claim 7 wherein said first computing and communications platform is a smartphone, tablet or personal computer.

9. The invention of claim 8 wherein said second computing platform is a server.

10. The invention of claim 9 wherein said second computing platform includes second software stored on a second tangible medium remote and independent from said first medium.

11. The invention of claim 10 wherein said second computing platform includes a second electronic processor independent of and remote from said first electronic processor that executes said second computer software to process said geo-fence based log data.

12. The invention of claim 9 wherein said first computing platform and second computing platform are coupled via the Internet.

13. The invention of claim 1 wherein said second computing platform is implemented via the Cloud.

14. The invention of claim 1 wherein said first computing platforms is a mobile computing and communications platform.

15. The invention of claim 14 further including means for sending a randomly generated code to said mobile computing and communications platform.

16. The invention of claim 15 further including means for verifying presence of a user at said location using a prompt incorporating said code.

17. A system for monitoring a presence of an individual in a remote location relative to a central facility comprising:
first means for receiving and storing location data on a first mobile computing and communications platform, said first means including:
first computer software stored in a first tangible medium for logging time at a location defined by geo-fence data and for biometrically identifying a user within said geo-fence and outputting data to said second computing platform with respect thereto,
a first electronic processor that executes said first computer software to store and transmit said geo-fence data and said authentication data; and
second means for transmitting receiving said time log at a second computing platform, said second computing platform including:
second software stored on a second tangible medium remote and independent from said first medium and
a second electronic processor independent of and remote from said first electronic processor that executes said second computer software to process said geo-fence based log data.

18. A method for monitoring a presence of an individual in a remote location relative to a central facility including the steps of:
receiving and storing geo-fence data;
logging time on first computing and communications platform at a location defined by said geo-fence data; and
transmitting said time log to a second computing and communications platform.
